(19) United States
(12) Patent Application Publication
(10) Pub. No.: US 2003/0140741 A1
(43) Pub. Date: Jul. 31, 2003

(54) ADJUSTABLE SLEEVE BARREL STRUCTURE

(76) Inventor: Chung-Shu Chang, Taichung (TW)

Correspondence Address: Charles Baxley, 59 John St., New York, NY, 10038, US

(21) Appl. No.: 10/055,934

(22) Filed: Jan. 28, 2002

(51) Int. Cl. B25B 13/18

(52) U.S. Cl. 81/128

(57) ABSTRACT

The present invention is an adjustable sleeve barrel structure comprising of a sleeve head, a sleeve body, and a set of pawls. The sleeve head is coupled on the bottom with the sleeve body, and both of them can rotate freely. The sleeve body has multiple slide rails distributed on its inner wall evenly. The pawls slide in these slide rails, and the shafts on the top of these pawls extrude to the space designed between the sleeve head and the sleeve body. Connected to the shafts are corresponding connecting rods, which have corresponding pins fixed onto the sleeve head. When the sleeve head rotates, it drives the pawls through the connecting rods to open/close simultaneously. In this way, when the operator turn the sleeve barrel clockwise/anti-clockwise, the pawls will screw a nut down/up together, which is convenient and practical.

### FIELD OF THE INVENTION

The present invention is an adjustable sleeve barrel structure comprising of a sleeve head, a sleeve body, and a set of pawls. The sleeve head is coupled on the bottom with the sleeve body, and both of them can rotate freely. The sleeve body has multiple slide rails distributed on its inner wall evenly. The pawls slide in these slide rails, and the shafts on the top of these pawls extrude to the space designed between the sleeve head and the sleeve body. Connected to the shafts are corresponding connecting rods, which have corresponding pins fixed onto the sleeve head. When the sleeve head rotates, it drives the pawls through the connecting rods to open/close simultaneously. In this way, when the operator turn the sleeve barrel clockwise/anti/clockwise, the pawls will screw a nut down/up together, which is convenient and practical.

### DESCRIPTION

1. Field of the Invention

This invention is an adjustable sleeve barrel structure with the purpose to lock/loose nuts of any size (in metric or English)/shape (male-tetragonal, male-hexagonal, female-tetragonal, or female-hexagonal) with the pawls opening/closing simultaneously at the bottom of the sleeve along with the rotation of the sleeve head.

2. Background of the Invention

Traditionally, multiple sleeve barrels of different sizes/shapes should be used to lock/loose nuts of different sizes/shapes. A complete set of these sleeve barrels will result in severe problems related with space, portability, convenience, and cost. Furthermore, if a sleeve barrel varies a bit in size/shape, further use of it will be a hard time.

In consideration of the shortcomings of legacy sleeve barrels, the inventor designed an adjustable sleeve barrel structure.

The main purpose of this invention is to provide an adjustable sleeve barrel structure to expand the application range of sleeve barrels.

The structure and purpose of this invention is detailed and illustrated as follows:

### BRIEF DESCRIPTION OF THE DRAWINGS

FIG. 1 is the 3D view of this invention.

FIG. 2 is the exploded view of this invention.

FIG. 3 is a sectional view of this invention.

FIG. 4 is the upward view of this invention.

FIG. 5 is a sectional view of the sleeve head of this invention.

FIG. 6 is the upward view of the sleeve head.

FIG. 7 is a sectional view of the sleeve head.

FIG. 8 is a sketch map of the connecting rod in its original position.

FIG. 9 is a sketch map of the pawl.

FIG. 10 is a sketch map of the connecting rod after rotation clockwise.

FIG. 11 is a sketch map of the pawl in another position.

FIG. 12 is a sketch map of the connecting rod after rotation anti-clockwise.

FIG. 13 is a sketch map of the pawl in the position shown in FIG. 12.

### Instruction of Legends

10 Sleeve Head

11 Sleeve Eye

12 Bearing

13 Shoulder

14 Plug Jack

20 Sleeve Body

21 Blind Hole 1

22 Blind Hole 2

23 Groove

24 Notch

25 Slide Rail

251 Gap Groove

30 Ouch

40 Pawl

41 Guided Groove

42 Shaft

43 Ouch

50 Connecting Rod

51 Eye 1

52 Eye 2

60 Pin

### DETAILED DESCRIPTION OF THE EMBODIMENTS

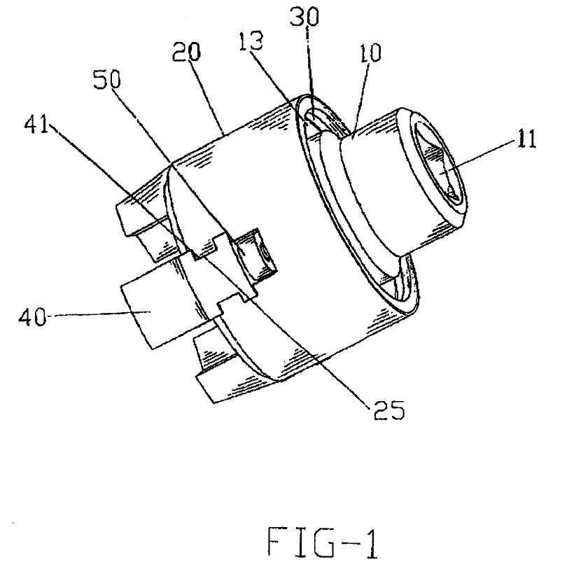

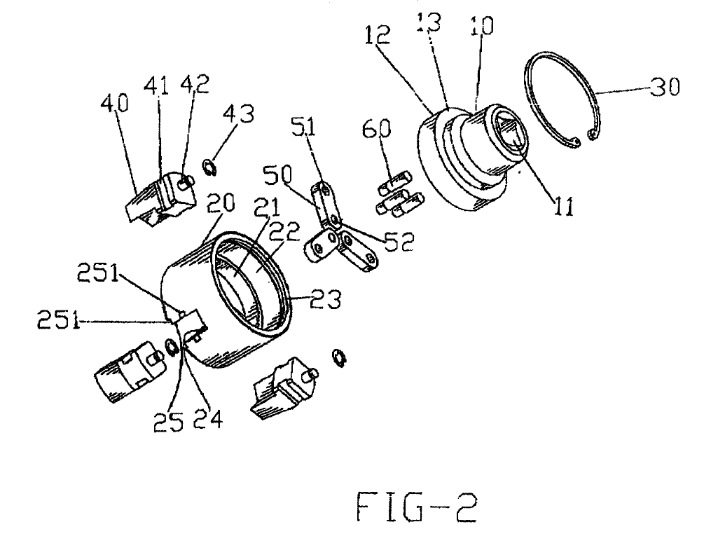

Please see FIG. 1 and FIG. 2. The sleeve barrel of this invention comprise of a sleeve head (10), a sleeve body (20), and a pawl (40), in which:

Sleeve head (10) has a sleeve eye (11) on one end, through which a wrench or ratchet wrench can be plugged to rotate sleeve head 10. On the other end of sleeve head 10 there is a bearing (12), forming the shoulder (13) with sleeve bead 10.

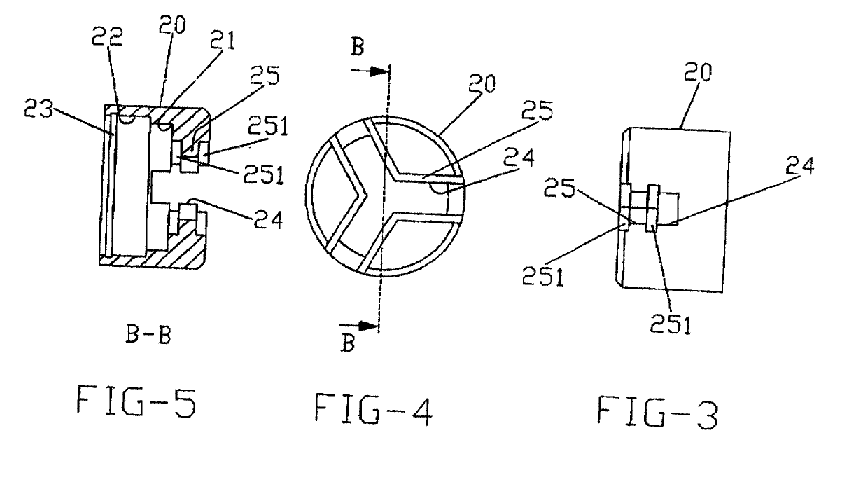

Please see FIG. 3, FIG. 4, and FIG. 5. The sleeve body is a cylinder structure with blind hole 1 (21) on one end. On blind hole 1 (21) there is a deeper and larger hole—blind hole 2 (22), through which the bearing (12) can be plugged and positioned at the shoulder (210) between blind hole 1 (21) and blind hole 2 (22). On blind hole 2 (22) there is a groove (23) at the position (13) sleeve head 10. The groove (23) can be controlled with the ouch (30) to position the bearing (12) of sleeve head 10 in sleeve body 20 and allow sleeve head 10 and sleeve body 20 to rotate freely.

At the bottom of sleeve body 20 there is a notch (24) running through blind hole 1 (21), and it has a slide rail (25) and a gap groove (251) on the bottom of slide rail 25.

Each of the three pawls (40) has a ramped camping surface in its inner sidewall and a guided groove (41) on the top, which can be coupled with slide rail 25 to make the three pawls extrude out of sleeve body 20 and slide freely. On the top of each pawl there is a shaft (42) located at the position of blind hole 1 (21) and enters into the corresponding eye of a connecting rod (50) to clamp the connecting rod (50) with the E-shape ouch (43) In this way, each of the three connecting rods can rotate freely on its corresponding shaft (42).

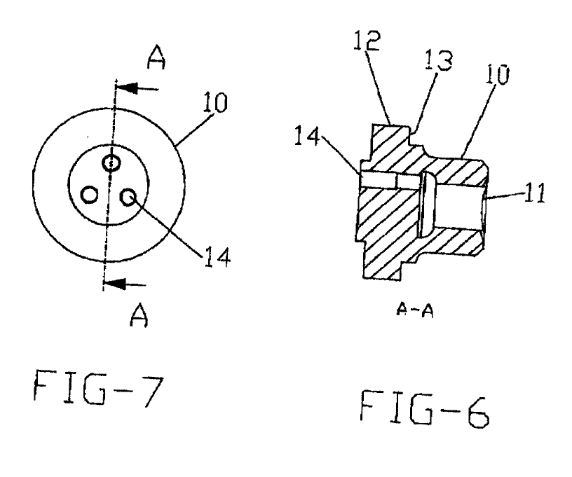

On each connecting rod (50) there is eye 2 (52), through which the pin (60) can be plugged, as shown in FIG. 6 and FIG. 7. There are 3 plug jacks (14) distributed evenly at the center of on side of the bearing (12) and can be used to position the bearing (12) with the pin (60).

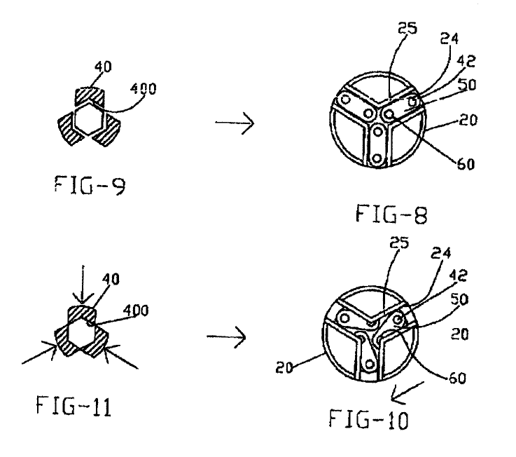

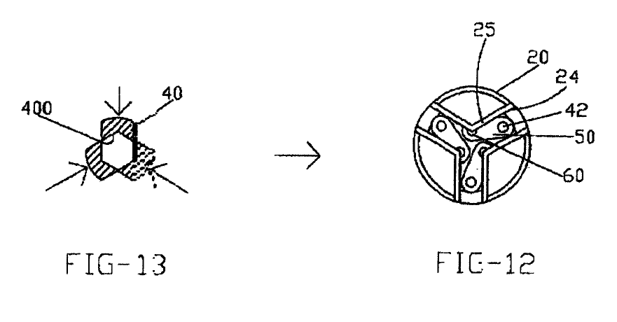

As shown in FIG. 8 and FIG. 9, when pin 60 is at the center of notch 24, the pawls (40) are at their farthermost positions. At this position, he blot to be screwed down/up can be placed among the three pawls (see also FIG. 10 and FIG. 11). If the operator turns sleeve head 10 clockwise, pins 60 will rotate clockwise to draw back the shaft (42) of each pawl (30) and make the clamping surfaces (400) of the three pawls (40) clamp the blot together. Along with the clockwise movement of sleeve head 10 under the drive of a wrench or ratchet wrench, the clamping surfaces (400) will clamp the bolt more and more firmly and screw down it.

Similarly, if the operator wants to screw up the bolt, he/she only needs to turn sleeve head 10 anti-clockwise to draw back pin 60 to the center of notch 24 to open the pawls (40) first, and then turn sleeve head 10 anti-clockwise continuously to draw back pins 60, which will make the clamping surfaces (400) of the pawls (40) clamp the bolt. Along with the anti-clockwise movement of sleeve head 10 under the drive of a wrench or ratchet wrench, the clamping surfaces (400) will clamp the bolt more and more firmly and screw up it.

Please note that only two sets of pawls (40), connecting rods (50), and pins (60) of this invention are necessary to make the invention work normally. That is to say, 3 or more sets of them are not prerequisite. Furthermore, the clamping surfaces (400) can be devised on the outer wall of the pawls (40) to work with female tetragonal bolts or female hexagonal bolts. The effective journey of this invention is independent to its components except for the pins (60) and the connecting rods (50).

What is claimed is:

1. An adjustable sleeve barrel structure comprising of a sleeve head, a sleeve body, and a set of pawls, in which the sleeve head has a sleeve eye on the top end, and is coupled on the bottom with the sleeve body, and both of them can rotate freely; the sleeve body has multiple slide rails distributed on its inner wall evenly; the pawls slide in these slide rails, and the shafts on the top of these pawls extrude to the space designed between the sleeve head and the sleeve body; connected to the shafts are corresponding connecting rods, which have corresponding pins fixed onto the sleeve head; when the sleeve head rotates, it drives the pawls through the connecting rods to open/close simultaneously.

2. The adjustable sleeve barrel structure of claim 1, in which on one end of the sleeve head there is a bearing, forming a shoulder with the sleeve head; the sleeve body is a cylinder structure with a blind hole (1) on one end, on which there is a deeper and larger hole (2), through which the bearing (12) can be plugged and positioned at the shoulder between blind hole (1) and blind hole (2); on blind hole (2) there is a groove at the position against the said sleeve head, and it can be controlled with the ouch to position the bearing of the sleeve head in the sleeve body and allow them to rotate freely.

3. The adjustable sleeve barrel structure of claim 1, in which at the bottom of the sleeve body there is a notch running through the said blind hole (1), and it has a slide rail and a gap groove on the bottom of the slide rail; each of the pawls has a ramped camping surface in its inner sidewall and a guided groove on the top, which can be coupled with the said slide rail to make the three pawls extrude out of the sleeve body and slide freely.

4. The adjustable sleeve barrel structure of claim 1, in which on the top of each pawl there is a shaft located at the position of the said blind bole (1) and enters into the corresponding eye of a connecting rod to clamp the connecting rod with the ouch; in this way, each of the three connecting rods can rotate freely on its corresponding shaft; on each connecting rod there is a eye (2), through which the pin can be plugged.

5. The adjustable sleeve barrel structure of claim 1 in which each pawl has a ramped camping surface in its inner sidewall.

6. The adjustable sleeve barrel structure of claim 1 or claim 5, in which each pawl has a ramped camping surface in its inner sidewall.
